(19) United States
(12) Patent Application Publication
(10) Pub. No.: US 2025/0390227 A1
(43) Pub. Date: Dec. 25, 2025

(54) ADDRESS OFFSET IN MEMORY

(71) Applicant: Micron Technology, Inc., Boise, ID (US)

(72) Inventors: Glen E. Hush, Boise, ID (US); Peter L. Brown, Eagle, ID (US); Timothy P. Finkbeiner, Boise, ID (US)

(21) Appl. No.: 19/245,706

(22) Filed: Jun. 23, 2025

Related U.S. Application Data
(60) Provisional application No. 63/663,399, filed on Jun. 24, 2024.

(51) Int. Cl. G06F 3/06

(52) U.S. Cl. CPC G06F 3/0613; G06F 3/0659; G06F 3/0673

(57) ABSTRACT

Address offset in memory is described herein. The controller of a memory device can receive an address associated with a bank of memory cells. The controller can access an address offset value that corresponds to the bank of memory cells. The controller can update the address utilizing the address offset value. The controller can provide the updated address to a row decoder. The row decoder can receive the updated address and activate a row of a bank of memory cells utilizing the updated address.

### PRIORITY INFORMATION

This application claims the benefit of U.S. Provisional Application No. 63/663,399, filed on Jun. 24, 2024, the contents of which are incorporated herein by reference.

### TECHNICAL FIELD

The present disclosure relates generally to memory, and more particularly to apparatuses and methods associated with providing an address offset in memory.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, and other electronic devices. Memory cells can be arranged into arrays, with the arrays being used in memory devices.

### BRIEF DESCRIPTION OF THE DRAWINGS

FIG. 1 is a block diagram of an apparatus in the form of a computing system including a memory device in accordance with a number of embodiments of the present disclosure.

FIG. 2 is a block diagram of a bank controller in accordance with a number of embodiments of the present disclosure.

FIG. 3 is a block diagram of a memory system having a plurality of banks of memory cells in accordance with a number of embodiments of the present disclosure.

FIG. 4 illustrates an example flow diagram of a method for providing an address offset in memory in accordance with a number of embodiments of the present disclosure.

FIG. 5 illustrates an example machine of a computer system within which a set of instructions, for causing the machine to perform any one or more of the methodologies discussed herein, can be executed.

### DETAILED DESCRIPTION

The present disclosure includes apparatuses and methods related providing an address offset in memory. A row decoder can be coupled to a bank of memory cells. A controller can be coupled to the row decoder. The controller can receive an address associated with the bank of memory cells. The controller can access an address offset value that corresponds to the bank of memory cells. The controller can update the address utilizing the address offset value. The controller can provide the updated address to the row decoder. The row decoder can receive the updated address and can activate a row of the bank of memory cells utilizing the updated address.

A controller of a memory device can provide (e.g., broadcast) an access command to multiple banks of memory cells to access data stored in the cells. Broadcasting a command to multiple banks can include providing the same access command to multiple banks concurrently. As used herein, providing access commands concurrently includes providing commands at relatively the same time. An access command can be broadcast to multiple banks using the same address. However, if the data being sought to be accessed is stored in the banks using different addresses, the data being sought may not be accessible using a broadcast access command, because broadcasting an access command does not include broadcasting different addresses in previous approaches.

In order to address these and other deficiencies of previous approaches, embodiments of the present disclosure store an address offset value in a memory device and use the address offset value to access a bank (e.g., to access the data stored in the memory cells of the bank). A different address offset value can be used to access each of the banks of a memory system. The address offset value can be used to modify an address used to access a bank. Using a different address offset value to access each of the banks can allow for an access command to be broadcast to each of the banks where the access command uses a same address and the address offset value to access each of the banks.

In various examples, data is stored in memory cells coupled to different sense (e.g., data) lines and/or access (e.g., word) lines. Data can be stored in memory cells coupled to different sense lines and/or word lines across multiple banks based on a storage pattern of the banks, among other reasons for storing data to different sense lines and/or word lines. The data can be weights of an artificial neural network (ANN), for example. In such instances, it may be beneficial to access the weights concurrently for execution of the ANN. However, the weights may be stored in memory cells coupled to different access lines and/or word lines across multiple banks. Address offset values can be used to access the weights using a single address (e.g., memory address) across multiple banks using a broadcast access command. The different address offset values, in combination with the single address, can be used to access the weights across multiple banks.

As used herein, ANNs can provide learning by forming probability weight associations between an input and an output. The probability weight associations can be provided by a plurality of nodes that comprise the ANN. The nodes together with weights, biases, and activation functions can be used to generate an output of the ANN based on the input to the ANN. A plurality of nodes of the ANN can be grouped to form layers of the ANN.

As used herein, artificial intelligence (AI) refers to the ability to improve an apparatus through “learning” such as by storing patterns and/or examples which can be utilized to take actions at a later time. Deep learning refers to a device's ability to learn from data provided as examples. Deep learning can be a subset of AI. Neural networks, among other types of networks, can be classified as deep learning. Improving the efficiency at which ANNs are executed can improve a function of a memory device executing the ANN and the function of the device in which the memory device is implemented. For example, improving the latency, power consumption, and/or throughput of the memory device implementing the ANN can cause an improvement to the latency, power consumption, and/or throughput of a memory system.

As used herein, “a number of” something can refer to one or more of such things. For example, a number of memory devices can refer to one or more memory devices. A “plurality” of something intends two or more. Additionally, designators such as “N,” as used herein, particularly with respect to reference numerals in the drawings, indicates that a number of the particular feature so designated can be included with a number of embodiments of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

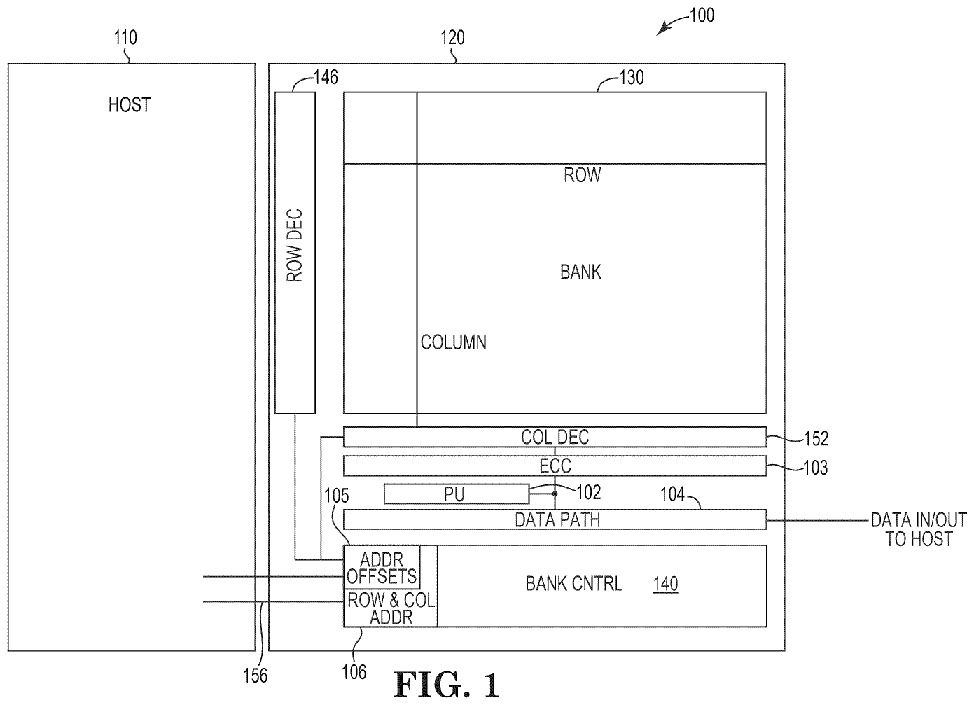

FIG. 1 is a block diagram of an apparatus in the form of a computing system 100 including a memory device 120 in accordance with a number of embodiments of the present disclosure. As used herein, a memory device 120, a bank 130 of memory cells, also referred to as a memory array 130, host 110, and/or the bank controller 140 (e.g., the controller 140) might also be separately considered an “apparatus.”

In this example, system 100 includes a host 110 coupled to memory device 120 via an interface 156. The computing system 100 can be a personal laptop computer, a desktop computer, a digital camera, a mobile telephone, a memory card reader, or an Internet-of-Things (IoT) enabled device, among various other types of systems. Host 110 can include a number of processing resources (e.g., one or more processors, microprocessors, or some other type of controlling circuitry) capable of accessing memory 120. The system 100 can include separate integrated circuits, or both the host 110 and the memory device 120 can be on the same integrated circuit. For example, the host 110 may be a system controller of a memory system comprising multiple memory devices 120, with the system controller 110 providing access to the respective memory devices 120 by another processing resource such as a central processing unit (CPU).

In the example shown in FIG. 1, the host 110 is responsible for executing an operating system (OS) and/or various applications that can be loaded thereto (e.g., from memory device 120 via controller 140). The host 110 can provide access commands and/or security mode initialization commands to a memory device via the interface 156.

For clarity, the system 100 has been simplified to focus on features with particular relevance to the present disclosure. The memory array 130 can be a DRAM array, SRAM array, STT RAM array, PCRAM array, TRAM array, RRAM array, NAND flash array, and/or NOR flash array, for instance. The array 130 can comprise memory cells arranged in rows coupled by access lines (which may be referred to herein as word lines or select lines) and columns coupled by sense lines (which may be referred to herein as digit lines or data lines). Although a single array 130 is shown in FIG. 1, embodiments are not so limited. For instance, memory device 120 may include a number of arrays 130 (e.g., a number of banks 130 of DRAM cells).

The memory device 120 includes address circuitry to latch address signals provided over the interface 156. The interface 156 can include, for example, a physical interface employing a suitable protocol (e.g., a data bus, an address bus, and a command bus, or a combined data/address/command bus). Such protocol may be custom or proprietary, or the interface 156 may employ a standardized protocol, such as Peripheral Component Interconnect Express (PCIe), Gen-Z, CCIX, or the like. Address signals are received and decoded by a row decoder 146 and a column decoder 152 to access the memory array 130. Data can be read from memory array 130 by sensing voltage and/or current changes on the sense lines using sensing circuitry. The sensing circuitry can comprise, for example, sense amplifiers that can read and latch a page (e.g., row) of data from the memory array 130. The I/O circuitry can be used for bi-directional data communication with host 110 over the interface 156. Read/write circuitry is used to write data to the memory array 130 or read data from the memory array 130.

Controller 140 decodes signals provided by the host 110. These signals can include chip enable signals, write enable signals, and address latch signals that are used to control operations performed on the memory array 130, including data read, data write, and data erase operations. In various embodiments, the controller 140 is responsible for executing instructions from the host 110. The controller 140 can comprise a state machine, a sequencer, and/or some other type of control circuitry, which may be implemented in the form of hardware, firmware, or software, or any combination of the three.

In various instances, the controller 140 can receive signals provided by the host 110 including signals requesting operations to be performed by a processing unit (PU) 102. As used herein, the PU 102 can include hardware and/or firmware for performing operations, such as, for example, multiplication operations, using data provided by the memory array 130 and/or the host 110.

In various examples, error correction code (ECC) circuitry 103 can receive data the memory array 130. The ECC circuitry 103 can perform error correction operations to correct errors in data sensed from the memory array 130. The PU 102 can be coupled to the ECC circuitry 103. The PU 102 can perform a plurality of operations on data received from the ECC circuitry 103. The PU 102 can provide an output to the data path 104. The data path 104 can provide data to the interface 156.

In various instances, the controller 140 (e.g., the bank controller) can include registers 105, 106. The register 105 can store address offset values that correspond to bank 130. The register 106 can store addresses associated with bank 130 (e.g., addresses of the memory cells of bank 130) received by controller 140 from host 110. The address offset values can be utilized (e.g., used), in combination with the addresses stored in the register 106, to generate updated addresses used to access data stored in the bank 130. The address offset values can be utilized (e.g., used) to update addresses of the bank 130 but may not be suitable for updating addresses of different banks. Although not shown in the example illustrated in FIG. 1, in some embodiments, registers 105 and/or 106 may located external to controller 140.

In various instances, the controller 140 can access and/or receive the address offset values stored in register 105, and utilize (e.g., use) the address offset values to update the addresses received from the host 110. For example, the controller can add the address offset values to the addresses received from the host 110 to generate an updated address. In various examples, the address offset values can be subtracted from the addresses to generate an updated address.

The address offset values can include column address offset values that correspond to columns of the bank 130 and/or row address offset values that correspond to rows of the bank 130. For instance, register 106 can be and/or include a column address offset value register and/or a row address offset value register. The column address offset values can be used to update a column address received from the host 110 and stored in the register 106. The row address offset values can be used to update a row address received from the host 110 and stored in the register 106. The column address and row address can be updated concurrently or sequentially.

The controller 140 can provide the updated column addresses to the column decoder 152. The controller 140 can provide the updated row addresses to the row decoder 146. The row decoder 146 can receive the updated row addresses, and utilize the updated row addresses to activate rows of the bank 130 having the updated row addresses. The column decoder 146 can receive the updated column addresses, and utilize the updated column addresses to activate columns of the bank 130 having the updated column addresses.

The address offset values can allow for a single address to be used to access data stored in different columns and/or rows of multiple banks using a single memory address. For example, the bank 130 can store a first plurality of weights of an artificial neural network in memory cells coupled to a first access line (e.g., row) while a different bank stores a second plurality of weights of the artificial neural network in memory cells coupled to a second access line, where the first access line and the second access line are different access lines. A first address can be used by row decoder 146 to activate the memory cells coupled to the first access line and a second address can be used by a row decoder coupled to the different bank to activate memory cells coupled to a second access line. PU 102 can receive the first plurality of weights responsive to row decoder 146 activating the first row, and a PU coupled to the different bank can receive the second plurality of weights responsive to the different row decoder activating the second row. A third address can be provided to a first bank controller and a second bank controller. The first bank controller can combine a first address offset value and the third address to generate the first address. The second bank controller can combine a second address offset value and the third address to generate the second address.

In various examples, a controller 140 can generate the address offset values stored in the register 105. For example, the controller 140 can receive data and a command to store the data in memory cells of bank 130 corresponding to an address. However, if the memory cells are already populated (e.g., already store different data), the controller can store the data in different memory cells corresponding to a different address in the bank. The controller 140 can generate the address offset values using the address and the different address. The controller 140 can store the address offset values in register 105 such that the controller 140 can update the address corresponding to the data using the different address and the address offset values. For example, the controller 140 can subtract the different address from the address to generate the address offset values. Controller 140 can then store the data in bank 135 utilizing the updated address. Controller 140 can store the address offset values in register 105 prior to receiving a command to provide the data to PU 102.

In various instances, the host 110 can generate the address offset values for each bank. For example, the host 110 can send data and a command to store the data in a first address of the bank (e.g., the bank 130) to controller 140. The host 110 can generate the address offset values by comparing the first address to a second address used to access the data across multiple banks. The host 110 can then send a command to the bank controller 140 to store the address offset values. If the host 110 generates the address offset values, then the host 110 can be aware that the data is stored in banks using different addresses. If the bank controller 140 generates the address offset values, then the host 110 may be unaware that the data is stored in banks using different addresses.

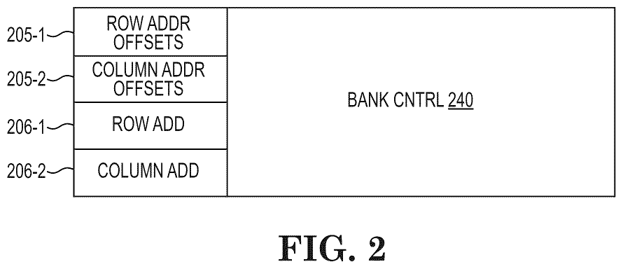

FIG. 2 is a block diagram of a bank controller 240 in accordance with a number of embodiments of the present disclosure. Bank controller 240 can be, for example, bank controller 140 previously described in connection with FIG. 1. The bank controller 240 can include registers 205-1, 205-2, referred to as registers 205, used to store address offset values. The bank controller 240 can also include registers 206-1, 206-2, referred to as registers 206, used to store addresses. Registers 205 and 206 can correspond to, for instance, registers 105 and 106, respectively, previously described in connection with FIG. 1.

For example, the register 205-1 can be a row address offset value register that stores a row address offset value. The register 205-2 can be a column address offset value register that stores a column address offset value. The register 206-1 can be a row address register that stores a row address and the register 206-2 can be a column address register that stores a column address. The address of the data stored in a bank of memory cells (e.g., bank 130 described in connection with FIG. 1) can be a combination of the row address and the column address. For example, the row address can be used to activate a row of memory cells. The column address can be used to activate columns of memory cells. The row decoder 146 previously described in connection with FIG. 1 can activate the row and the column decoder 152 previously described in connection with FIG. 1 can activate the columns of the bank.

In various examples, the bank controller 240 can include (e.g., be implemented with) the registers 205-1 and/or the registers 205-2. For example, in some embodiments, the bank controller 240 can be implemented with the register 205-1 but not the register 205-2 such that the bank controller 240 can update (e.g., modify) row addresses (e.g., by adding address offset values to the row addresses) but not modify column addresses. In an additional example, the bank controller 240 can be implemented with the register 205-2 but not the register 205-1 such that the bank controller 240 can modify column addresses (e.g., by adding address offset values to the column addresses) but not modify the row addresses. The bank controller 240 can also be implemented with the registers 205-1 and the registers 205-2 such that the bank controller 240 can modify both row and column addresses (e.g., by adding row address offset values to the row addresses and column address offset values to the column addresses).

In various examples, although the bank controller 240 can be implemented with the registers 205-1 and the registers 205-2, the bank controller 240 can update (e.g., modify) a row address and not a column address, or vice versa. For example, the memory cells coupled to an access line may have a row address, but the memory cells coupled to the sense lines may not have the column address provided by the host. The bank controller 240 can add the column address offset values to the column address to correctly activate the cells that store desired data (e.g., weight values).

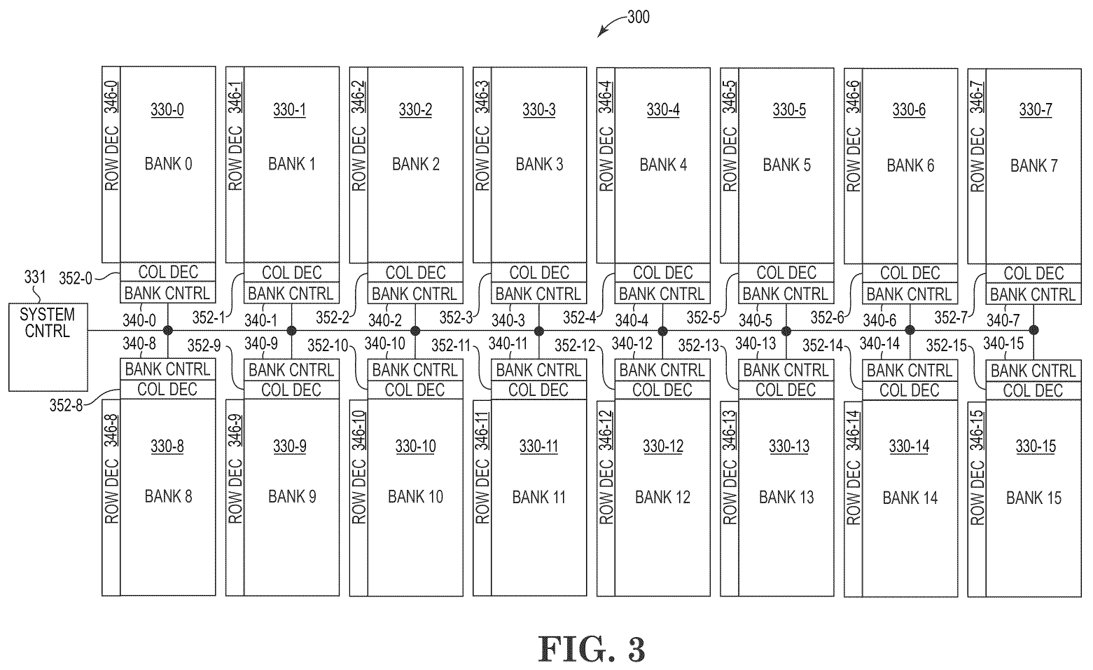

FIG. 3 is a block diagram of a memory system 300 having a plurality of banks of memory cells in accordance with a number of embodiments of the present disclosure. The banks 330-0, 330-1, 330-2, 330-3, 330-4, 330-5, 330-6, 330-7, 330-8, 330-9, 330-10, 330-11, 330-12, 330-13, 330-14, 330-15 can be referred to collectively as banks 330. The banks 330 can be analogous to bank 130 previously described in connection with FIG. 1. Further, although 16 banks are shown in the example illustrated in FIG. 3, embodiments of the present disclosure are not limited to a particular number of banks. The memory system 300 can also include a system controller 331.

The system controller 331 can send (e.g., broadcast) commands and addresses to the banks 330. For example, the system controller 331 can broadcast a read command to the memory devices that include the banks 330. The system controller 331 can broadcast the same command and the same address to each of the memory devices that include the banks 330. The memory devices can receive different instances of the same command. For example, each of the memory devices can receive a different instance of the same command and/or address at the bank controllers 340-0, 340-1, 340-2, 340-3, 340-4, 340-5, 340-6, 340-7, 340-8, 340-9, 340-10, 340-11, 340-12, 340-13, 340-14, 340-15, referred to collectively as bank controllers 340 and analogous to controller 140 previously described in connection with FIG. 1. The system controller 331 can broadcast the same command and/or the same address(es) to each of the bank controllers 340 at relatively the same time (e.g., concurrently).

Each of the bank controllers 340 can update the received addresses by utilizing their respective address offset values (e.g., by adding their respective address offset values to the received addresses). For example, the bank controller 340-1 can add a first address offset value to the received address to access the desired data. The bank controller 340-2 can add a second address offset value to the received address to access the desired data, where the first address offset value and the second address offset value can be different address offset values. The remaining bank controllers 340 can modify the received address to generate updated addresses in a similar manner.

The bank controller 340 can provide the updated addresses to the row decoders 346-0, 346-1, 346-2, 346-3, 346-4, 346-5, 346-6, 346-7, 346-8, 346-9, 346-10, 346-11, 346-12, 346-13, 346-14, 346-15, collectively referred to as row decoders 346 and analogous to row decoder 146 previously described in connection with FIG. 1, and the column decoders 352-0, 352-1, 352-2, 352-3, 352-4, 352-5, 352-6, 352-7, 352-8, 352-9, 352-10, 352-11, 352-12, 352-13, 352-14, 352-15, collectively referred to as column decoders 352 and analogous to column decoder 152 previously described in connection with FIG. 1. The row decoders 346 and the column decoders 352 can activate sense lines and access lines (e.g., columns and rows) of the banks 330 to sense (e.g., read) desired data.

In various instances, the address offset values can be used to program data to the banks 330. For example, the host can previously have stored address offset values in the address offset registers of bank controllers 340 utilizing the system controller 331. The host can provide an address offset value and an identifier of a bank to the system controller 331. The system controller 331 can provide the address offset value to the address offset register of a bank controller 340 of the identified bank 330. The bank controller 340 can store the address offset value in the register of the bank controller 340.

Thereafter, the host can provide a write command for one or more of the banks 330 to the system controller 331. The system controller 331 can provide the write command and corresponding data to the controller 340 of the one or more of the banks 330. The controller 340 of the one or more of the banks 330 can utilize the address offset values to program the corresponding data.

In various examples, the addresses provided to the bank controller 340 can be within a predefined address range. The address range can include a first address and a last address. The addresses of the address range can increment from the first address to the last address. In some examples, adding the address offset value to an address can cause the address to be incremented such that the address is increased past the last address. An address that is past the last address may be invalid and/or may not be suitable to access the desired data. Upon detecting that the last address has been reached, the bank controller 340 can wrap around to the first address and continue to sum the address offset values to the first address. Wrapping around from the last address to the first address can ensure that the combination of the addresses are provided, and the address offset values generate updated addresses that are valid.

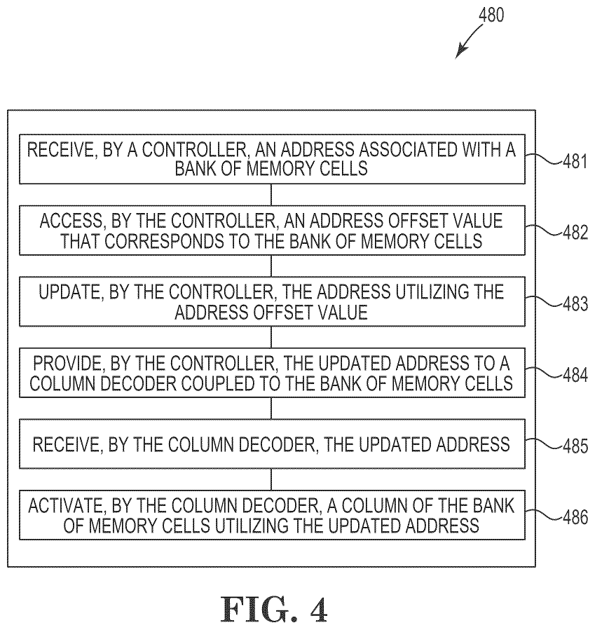

FIG. 4 illustrates an example flow diagram of a method 480 for providing an address offset in memory in accordance with a number of embodiments of the present disclosure. The method can be performed by a memory device of a computing system, such as, for instance memory device 120 of computing system 100 previously described in connection with FIG. 1.

At 481, a controller (e.g., bank controller) can receive an address associated with a bank of memory cells. The controller can be a bank controller coupled to a row decoder. The controller can be a bank controller 140 of FIG. 1. The row decoder can be coupled to the bank of memory cells. The address can be an address that is sent to multiple controllers of multiple memory devices.

At 482, the controller can access an address offset value that corresponds to the bank of memory cells. The address offset value can be stored in a register that is internal to the controller or external to the controller but internal to the memory device.

At 483, the controller can update the address utilizing the address offset value. For example, the controller can add the address offset value to the address or subtract the address offset value from the address.

At 484, the controller can provide the updated address to the column decoder. At 485, the column decoder can receive the updated address. The column decoder can be coupled to the controller. The column decoder can be, for example, the column decoder 152 and 352 of FIGS. 1 and 3, respectively.

At 486, the column decoder can activate a column of the bank of memory cells utilizing the updated address. For example, the column decoder can activate a sense line of the bank of memory cells to sense data from memory cells coupled to the sense line.

The controller can access the address offset value from a column address offset value register included in the controller. The column address offset value register can be included in the controller (e.g., bank controller). For example, the bank controller can include a column address offset value register storing a column address offset value and a row address offset value register storing a row address offset value. The column address offset value can be used to update (e.g., modify) column addresses while the row address offset value can be used to modify row addresses. In some examples, the address offset value can be accessed from a column address offset value register that is external to the bank controller but internal to a memory device that includes the bank controller.

The address can be modified by adding the address offset value to the address to generate the updated address. The address can also be modified by subtracting the address offset value from the address to generate the updated address.

The controller can receive data and the address corresponding to the data. The controller can receive the data and the address prior to the data being stored in a bank coupled to the controller. The controller can update the address corresponding to the data utilizing the address offset value prior to storing the data in a bank coupled to the controller. The controller can store the data in the bank of memory cells utilizing the updated address corresponding to the data. For example, the controller can provide the updated address(es) to the row decoder and the column decoder. The row decoder and the column decoder can activate sense lines and/or word lines of the bank to store the data in the memory cells coupled to the sense lines and/or word lines.

In various examples, the memory system can include a bank of memory cells, a row decoder, a bank, and a controller coupled to the row decoder. The controller can receive an address associated with the bank of memory cells. The controller can receive the address along with a command to read data from the bank. The controller can access an address offset value that corresponds to the bank of memory cells responsive to receipt of the address. For example, the controller can read the address offset value from a register of the controller. The controller can also receive the address offset value from a source external to the controller. The term access is intended to include multiple forms of obtaining the address offset value.

The controller can update the address utilizing the address offset value. For example, the controller can add the address and the address offset value to generate an updated address offset value. The controller can also subtract the address offset value from the address to generate the updated address offset value.

The controller can provide the updated address to the row decoder. The row decoder can receive the updated address. The row decoder can activate a row of a bank of memory cells utilizing the updated address.

The memory system can also include an address offset register. The address offset register can store the address offset value. In various instances, the address offset register can be internal to the controller. The controller can access the address offset value from the address offset register.

The memory system can include a bank of memory cells. The bank of memory cells can be an array of memory cells. The bank of memory cells can store a plurality of weights of an artificial neural network in memory cells coupled to the row of the bank. As used herein, memory cells coupled to a row can reference memory cells coupled to a word line of the bank. Memory cells coupled to a column can reference memory cells coupled to a sense line of the bank.

The memory system can include a PU. The PU can receive the plurality of weights responsive to the row decoder activating the row of the bank. For example, the activation of the word line of the bank can cause the memory cells coupled to the word line to be sensed by sensing circuitry. The sensing circuitry can provide the data to the ECC circuitry. The ECC circuitry can provide the data to the PU.

An additional row decoder can be coupled to an additional bank of memory cells. An additional controller can be coupled to the additional row decoder. The additional controller can receive an address associated with the additional bank of memory cells. The additional controller can access an address offset value that corresponds to the additional bank of memory cells. The additional controller can update the address associated with the additional bank of memory cells utilizing the address offset value that corresponds to the additional bank of memory cells. The additional controller can also provide the updated address associated with the additional bank of memory cells to the additional row decoder.

The additional row decoder can receive the updated address associated with the additional bank of memory cells. The additional row decoder can activate a row of the additional bank of memory cells utilizing the updated address associated with the additional bank of memory cells.

The address offset value can correspond to a bank of memory cells. Each bank of memory cells can be associated with a different address offset value. In some examples, the address offset value can be equal to the 0-value if the address is equal to the updated address.

The controller can receive the address offset value. The controller can store the address offset value in an address offset register. The controller can store the address offset value in the address offset register prior to receipt of a command to provide data to the PU.

In various instances, the apparatus can include a bank of memory cells, a column decoder coupled to the bank of memory cells, a row decoder coupled to the bank of memory cells, and a controller coupled to the column decoder and the row decoder. The controller can receive a first address associated with the bank of memory cells. The first address can be a row address. The controller can also receive a second address associated with the bank of memory cells. The second address can be a column address. The controller can access a row address offset value and/or a column address offset value that correspond to a row and a column, respectively, of the bank of memory cells.

The controller can update the first address utilizing the row address offset value. The controller can update the second address utilizing the column address offset value. The controller can provide the updated first address to the row decoder and the updated second address to the column decoder coupled to the bank of memory cells.

The row decoder can receive the updated first address from the controller. The row decoder can activate the row of the bank utilizing the updated first address. The column decoder can receive the updated second address. The column decoder can activate a column of the bank of memory cells utilizing the updated second address.

The controller can update the first address and the second address concurrently. The controller can update the first address and the second address sequentially.

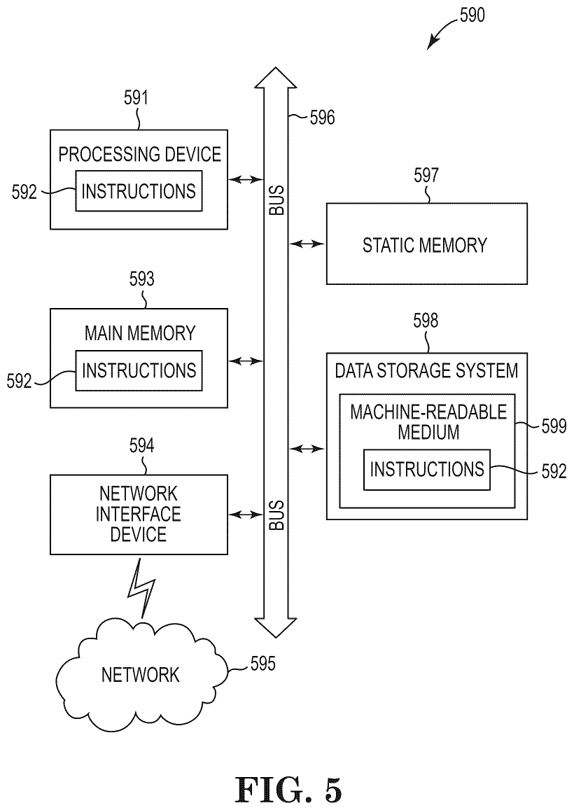

FIG. 5 illustrates an example machine of a computer system 590 within which a set of instructions, for causing the machine to perform any one or more of the methodologies discussed herein, can be executed. In some embodiments, the computer system 590 can correspond to a host system (e.g., the host 110 of FIG. 1) that includes, is coupled to, or utilizes a memory system (e.g., the memory device 120 of FIG. 1) or can be used to perform the operations of the controller (e.g., the controller 140 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 590 includes a processing device 591, a main memory 593 (e.g., read-only memory (ROM), flash memory, dynamic random access memory (DRAM) such as synchronous DRAM (SDRAM) or Rambus DRAM (RDRAM), etc.), a static memory 597 (e.g., flash memory, static random access memory (SRAM), etc.), and a data storage system 598, which communicate with each other via a bus 596.

Processing device 591 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 591 can also be one or more special-purpose processing devices such as an application specific integrated circuit (ASIC), a field programmable gate array (FPGA), a digital signal processor (DSP), network processor, or the like. The processing device 591 is configured to execute instructions 592 for performing the operations and steps discussed herein. The computer system 590 can further include a network interface device 594 to communicate over the network 595.

The data storage system 598 can include a machine-readable storage medium 599 (also known as a computer-readable medium) on which is stored one or more sets of instructions 592 or software embodying any one or more of the methodologies or functions described herein. The instructions 592 can also reside, completely or at least partially, within the main memory 593 and/or within the processing device 591 during execution thereof by the computer system 590, the main memory 593 and the processing device 591 also constituting machine-readable storage media.

In one embodiment, the instructions 592 include instructions to implement functionality corresponding to the controller 140 of FIG. 1. While the machine-readable storage medium 599 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a bank of memory cells;
a row decoder coupled to the bank of memory cells; and
a controller coupled to the row decoder and configured to:
receive an address associated with the bank of memory cells;
access an address offset value that corresponds to the bank of memory cells;
update the address utilizing the address offset value; and
provide the updated address to the row decoder; and
wherein the row decoder is configured to:
receive the updated address; and
activate a row of the bank of memory cells utilizing the updated address.

2. The apparatus of claim 1, further comprising an address offset register configured to store the address offset value.

3. The apparatus of claim 2, wherein the controller includes the address offset register.

4. The apparatus of claim 1, wherein the bank of memory cells is configured to store a plurality of weights of an artificial neural network in memory cells coupled to the row of the bank.

5. The apparatus of claim 4, further comprising a processing unit configured to receive the plurality of weights responsive to the row decoder activating the row of the bank.

6. The apparatus of claim 1, further comprising:
an additional bank of memory cells;
an additional row decoder coupled to the additional bank of memory cells; and
an additional controller coupled to the additional row decoder and configured to:
receive an address associated with the additional bank of memory cells;
access an address offset value that corresponds to the additional bank of memory cells;
update the address associated with the additional bank of memory cells utilizing the address offset value that corresponds to the additional bank of memory cells; and
provide the updated address associated with the additional bank of memory cells to the additional row decoder; and
wherein the additional row decoder is configured to:
receive the updated address associated with the additional bank of memory cells; and
activate a row of the additional bank of memory cells utilizing the updated address associated with the additional bank of memory cells.

7. The apparatus of claim 1, wherein the controller is further configured to receive the address offset value.

8. The apparatus of claim 7, wherein the controller is further configured to store the address offset value in an address offset register.

9. The apparatus of claim 8, wherein the controller is further configured to store the address offset value in the address offset register prior to receipt of a command to provide data to a processing unit.

10. A method, comprising:
receiving, by a controller, an address associated with a bank of memory cells;
accessing, by the controller, an address offset value that corresponds to the bank of memory cells;
updating, by the controller, the address utilizing the address offset value;
providing, by the controller, the updated address to a column decoder coupled to the bank of memory cells;
receiving, by the column decoder, the updated address; and
activating, by the column decoder, a column of the bank of memory cells utilizing the updated address.

11. The method of claim 10, further comprising accessing the address offset value from a column address offset value register included in the controller.

12. The method of claim 10, further comprising accessing the address offset value from a column address offset value registers external to the controller.

13. The method of claim 10, wherein updating the address includes adding the address offset value to the address to generate the updated address.

14. The method of claim 10, further comprising receiving data by the controller.

15. The method of claim 14, further comprising receiving an address corresponding to the data by the controller.

16. The method of claim 15, further comprising updating the address corresponding to the data utilizing the address offset value.

17. The method of claim 16, further comprising storing the data in the bank of memory cells utilizing using the updated address corresponding to the data.

18. An apparatus, comprising:
a bank of memory cells;
a column decoder coupled to the bank of memory cells;
a row decoder coupled to the bank of memory cells; and
a controller coupled to the row decoder and the column decoder, and configured to:
receive a first address associated with the bank of memory cells;
receive a second address associated with the bank of memory cells;
access a row address offset value that corresponds to a row of the bank of memory cells;
access a column address offset value that corresponds to a column of the bank of memory cells;
update the first address utilizing the row address offset value;
update the second address utilizing the column address offset value; and
wherein the row decoder is configured to:
receive the updated first address; and
activate the row of the bank utilizing the updated first address; and
wherein the column decoder is configured to:
receive the updated second address; and
activate the column of bank utilizing the updated second address.

19. The apparatus of claim 18, wherein the controller is further configured to update the first address and the second address concurrently.

20. The apparatus of claim 18, wherein the controller is further configured to update the first address and the second address sequentially.
